(19) United States
(12) Patent Application Publication
(10) Pub. No.: US 2003/0227152 A1
(43) Pub. Date: Dec. 11, 2003

(54) Inner tangentially driving wheel

(76) Inventor: Shih-Ming Huang, Hsien (TW)

Correspondence Address: Chi Fa Intellectual Economy, International Co., Ltd., P.O. Box No. 6-57, Chung-Ho, Taipei, 235, TW

(21) Appl. No.: 10/189,008

(22) Filed: Jul. 5, 2002

(30) Foreign Application Priority Data
Jun. 7, 2002 (TW) 91112282

(51) Int. Cl. B62K 1/00

(52) U.S. Cl. 280/205

(57) ABSTRACT

An inner tangentially driving wheel providing a driving apparatus at the position on a tangent line of the inner circle of the wheel to lower a position of a force exertion point mainly includes a driving apparatus disposed at the position of an inner circle tangent point at the lower aspect of the inner circle of the wheel. The driving apparatus is supported by a railing device respectively disposed on bisecting angles at the upper aspect thereof to efficiently and tangentially move a motion wheel which moves oppositely; through the operation of an external force, it drives the motion wheel in an inner tangentially driving type thereby defining an hollow state on the inner arcuate plane of the wheel so as to lower the position of the force exertion point for operation and provide extensive applications for various kinds of exerciser or toys.

### BACKGROUND OF THE INVENTION

1) Field of the Invention

The present invention relates to an inner tangentially driving wheel, more especially to a wheel driving method having a driving apparatus tangentially disposed at a position of an inner circle tangent point at the lower aspect of the inner circle. The driving apparatus tangentially moves to indirectly and tangentially move the wheel on an outer periphery to lower the operation position of the wheel thereby relatively lowering the center of gravity of a force exertion point so as to achieve an objective of driving safely and stably.

2) Description of the Prior Art

The design of an exerciser, a toy or a transportation means absolutely requires a driving wheel for making movement; for example, a rear wheel of a bicycle has a wheel with an inner breadth plane connected with a hub through spoke rods; the center of the wheel is coaxially assembled by a passive gear through a chain or any other driving methods, to transmit an epicyclical couple to the wheel via the spoke rods for achieving a driving objective; or, for example, a wheel disposed on an exerciser might have spoke rods connected with a hub toward the center of the wheel or have a circular board body connected with a wheel tire frame on the outer circle, a hub connected at the center and similarly a coaxially jointed gear or belt wheel to transmit through an external force for driving the wheel.

However, the work efficiency of a transportation means and an exerciser requires different designs. For a transportation means, it is necessary to reach the highest converting efficiency of the dynamic force; however, the design of an exerciser is oriented to a reverse direction to lower the efficiency of the force transmission in order to increase the degree an exerciser's force exertion so as to achieve the exercise for muscles and bones. The design of a traditional wheel uses a central point as a supporting point and has the least resistance of the moment of force and that is not suitable for being applied onto an exerciser. Furthermore, the inner breadth plane of the wheel connects with the spoke rods to install elements and has an axel center. Therefore, after being applied to any transportation means or exerciser and the main body structure is connected with the wheel, the center of gravity of the platform will be either too high or not able to meet the cooperative requirement of various new style designs.

### SUMMARY OF THE INVENTION

Therefore, the primary objective of the present invention is to design an hollow interior portion of a wheel and dispose an inner tangentially driving apparatus at the position of the tangent point on the bottom portion of the inner circle of the wheel thereby lowering the force exertion point for operation and providing an application of a lower chassis. After being activated by an external force, the inner tangentially driving apparatus transmits the epicyclical force to indirectly mesh with a motion wheel on the outer circle to make the motion wheel obtain a brand new application of using a dynamic force to drive and proceed.

The secondary objective of the present invention is to dispose a unidirectional engaging apparatus to unidirectionally and movably fasten a driving shaft of the driving apparatus thereby preventing the feedback action force of the motion wheel.

The third objective of the present invention is to make the driving apparatus move frictionally.

The fourth objective of the present invention is that the inner tangentially driving apparatus indirectly meshes and moves the motion wheel in a gear engaging method.

The fifth objective of the present invention is to provide a railing device for railing and positioning the entire driving apparatus by disposing a lateral guide wheel to achieve the objective of sliding tangentially and railing on the circumferential surface.

The sixth objective of the present invention is to enlarge the epicyclical velocity inside the driving apparatus through a method of gear link and enlargement via a lapped assembly of the big and the small gears.

The seventh objective of the present invention is to adopt a planetary gear set as a mechanism inside the driving apparatus to enlarge the epicyclical velocity.

The eighth objective of the present invention is to lap the gears to enlarge the epicyclical velocity by disposing a unidirectional engaging apparatus between a passive gear and a spinning disk.

The ninth objective of the present invention is to use a planetary driving apparatus by disposing a unidirectional engaging apparatus between the sun gear and the spinning disk.

The tenth objective of the present invention is to combine the inner tangentially driving wheel with a car frame to form a man-power leisure exerciser by mainly comprising an inner driving apparatus relatively disposed at the position on a inner circle tangent point at the lower aspect inside the wheel. The car frame extends outwardly from a fastened position in relation to the installation of the driving apparatus and has a seat as well as another rear wheel to form the man-power leisure exerciser.

The eleventh objective of the present invention is that the rear wheel of the man-power leisure exerciser is a mechanism comprising a rear wheel using the pressure difference of gravity to deflect for steering the exerciser dispensing with a manual operation.

The twelfth objective of the present invention is that at least two sets of inner tangentially driving wheels are disposed coaxially on the left and side sides to efficiently lower the entire chassis of the formed exerciser.

The thirteenth objective of the present invention is that on the driving wheel of the exerciser disposed with a lower chassis, a shield tube protects the upper position thereof to prevent the user from touching the wheel, to form a protection for an external force and by acting as a handle bar for gripping.

The fourteenth objective of the present invention is that a railing device disposed between a link wheel frame and an inner hoop body is of a sliding and placing relationship between a sliding channel and a sliding rail to achieve sliding and railing purposes.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a lateral drawing of the structure of the present invention.

FIG. 2 is a schematic drawing of a railing device relatively linking a link wheel frame of the present invention.

FIG. 3 is a basic structural drawing of a driving apparatus of the present invention.

FIG. 4 is a schematic drawing of a connection relationship as the driving apparatus of the present invention frictionally moves a motion wheel.

FIG. 5 is a schematic drawing of the driving apparatus of the present invention engagingly moves the motion wheel.

FIG. 6 is a structural and schematic drawing the driving wheel of the present invention adopting lapped gears to enlarge an epicyclical velocity.

FIG. 7 is a structural and schematic drawing of the driving apparatus of the present invention using a planetary gear set as an enlargement mechanism.

FIG. 8 is a lateral drawing of a relative structure of the present invention of a man-power leisure exerciser with an inner tangentially driving apparatus.

FIG. 9 is a bird's eye view of the drawing of an embodiment of the man-power leisure exerciser of the present invention.

FIG. 10 is a rear view drawing of the embodiment of the man-power leisure exerciser of the present invention.

FIG. 11 is a schematic drawing of a man-power bicycle of the present invention.

FIG. 12 is a schematic drawing of a man-power driving car of the present invention.

FIG. 13 is pictorial and schematic drawing of the relative structure of the present invention with a lower chassis.

FIG. 14 is a schematic drawing of the coupling relationship between the driving apparatus of the present invention and treadle pedals.

FIG. 15 is a schematic drawing of a railing device of a sliding channel of the present invention.

### DETAILED DESCRIPTION OF THE PREFERRED EMBODIMENTS

The present invention of an inner tangentially driving wheel is particularly a driving wheel providing a driving application for an exerciser or a transportation means. More especially, the driving method thereof uses an inner tangentially driving apparatus disposed at the position of an inner circle tangent point of the wheel to obtain a dynamic force of an epicycle via a manpower to drive an externally fastened motion wheel so as to fulfill the special application of lowering the operation position and the position of the center of gravity.

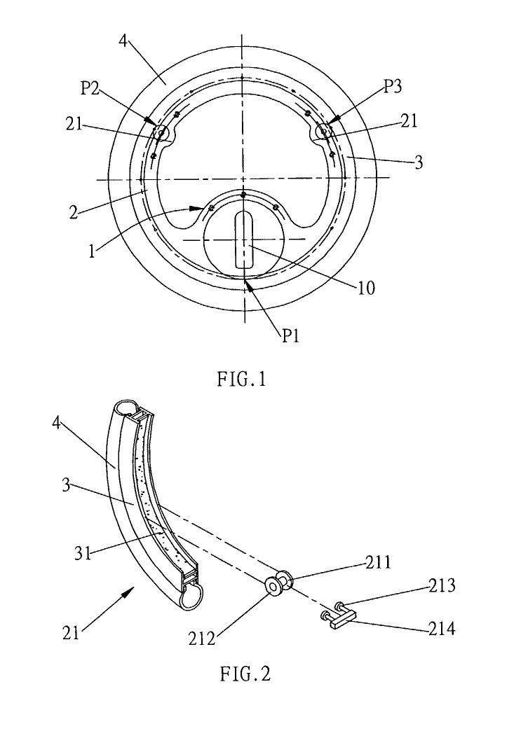

Referring to FIG. 1, the present invention of an inner tangentially driving wheel mainly comprises an inner tangentially driving apparatus (1) with a treadle pedal (10) disposed on the outer side; via an inner hoop body (2), the entire body is relatively installed on a tangent point (PI) of a lower circle of a link wheel frame (3); railing devices (21) are respectively disposed at the positions of ten o'clock and ten minutes past the hour on the inner hoop body (2) relative to the wheel; the railing devices (21) are situated respectively at the positions of the tangent points (P2, P3) of the left and right circles at the upper aspect. The inner driving apparatus (1) and the inner hoop body (2) are a relative structure assembled unitarily that moves relatively and oppositely on an inner circular plane of the link wheel frame (3) through the tangent points (P1, P2, P3); the outer rim of the link wheel frame (3) is encased in a motion wheel (4).

Referring to FIG. 2, a railing wheel (211) of the railing device (21) uses a circular tangent method to tangentially press the inner web portion of the link wheel frame (3) and is movably fastened to a relative position on the inner hoop body (2) by a shaft hole (212), as also indicated in FIG. 1. The tangential press of the railing wheel (211) allows the inner hoop body (2) to make even friction thereby efficiently maintaining in the interior portion of the center of the motion wheel (4) and aligning with an invisible central point so as to prevent the inner hoop body (2) from deflection; furthermore, the railing wheel (211) moving in the web portion of the link wheel frame (3) also assures that the inner hoop body (2) won't deflect and stagger the link wheel frame (3). In addition, the rail device (21) can be indirectly and movably fastened on the inner hoop body (2) (not shown) via a wheel frame (214) by using the circular surface of a lateral guide wheel (213) to tangentially slide on the inner lateral side of the link wheel frame (3) for railing applications of other kinds of elements.

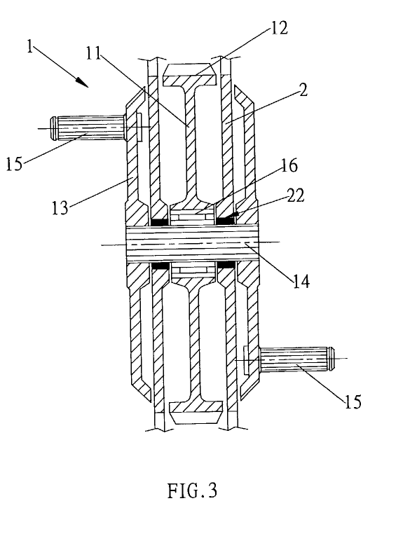

Referring to FIG. 3, the driving apparatus (1) of the present invention is mainly assembled by two lateral rotary disks (13) disposed with two eccentric shafts (15) at 180 degree diagonally on the outer sides. The eccentric shafts (15) receive an external force to transmit a dynamic force, such as a pedaling force for a bicycle. As indicated in a bird's eye and cross-sectional view, it is obvious that the driving apparatus (1) of the present invention basically comprises a driving shaft (14) movably fastened through an inner circular hole (22) disposed at the center of the inner hoop body (2); the rotary disk (13) and the driving shaft (14) are fixedly jointed for assembly; the center of the driving shaft (14) links a driving wheel (11) disposed with a engaging plane (12) on the outer circular surface thereof. A unidirectional engaging apparatus (16) is disposed between the driving wheel (11) and the driving shaft (14) to act as a unidirectional shaft bearing for one-way driving. The engaging apparatus (16) allows the eccentric shafts (15), for example, a treadle board or a rocker rod to be activated by an external force, to transmit a dynamic force toward the driving shaft (14) unidirectionally, and indirectly transmit the dynamic force toward the driving wheel (11) via the unidirectional engaging apparatus (16) to make the engaging plane (12) thereof indirectly mesh the motion wheel (4) to output the transmitted dynamic force.

After the two eccentric shafts (15) are alternatively pedaled to rotate and with enough driving inertia, the unidirectional engaging apparatus (16) make the driving shaft (14) and the driving wheel (11) release unidirectionally to avoid the inertia force from the driving wheel (11) to reversely transmit toward the driving shaft (14) thereby allowing the user's foot to obtain a static rest.

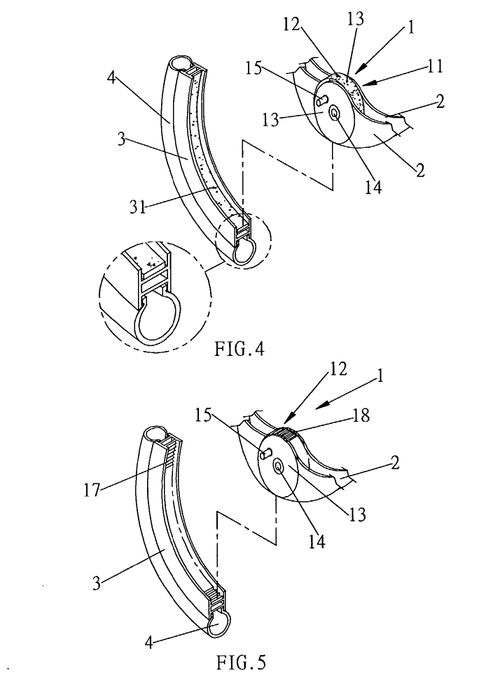

Referring to FIG. 4, the driving apparatus (1) meshes in a frictional method, wherein the entire driving apparatus (1) is movably fastened onto the inner hoop body (14); the rotary disk (13) receives and transmits the dynamic force obtained by the eccentric shafts (15) toward the driving shaft (14); then the driving shaft (14) transmits the epicyclical and dynamic force to the driving wheel (11) thereby make the engaging plane (12) move frictionally to a friction ring (31) disposed in the web portion of the link wheel frame (3) received in the interior portion of the motion wheel (4). The friction ring (31) is made of friction-resistant material capable of receiving a frictional material, such as frictional fabric or rubber material.

Referring to FIG. 5, an inner annular cog (17) is disposed in the web portion of the link wheel frame (3) disposed in relation to the motion wheel (4) of the driving apparatus (1) of the present invention and is engaged by a mesh cogged ring (18) disposed in the driving apparatus (1). Similarly, the eccentric shafts (15) transmit the dynamic force to the driving shaft (14) via the rotary disk (13), output the dynamic force toward the mesh cogged ring (18) and then indirectly transmit the driving dynamic force toward the motion wheel (4) through meshing the inner annular cogs (17). This method specifies the epicyclical opposite relationship thereby facilitating the application of transmitting heavier load.

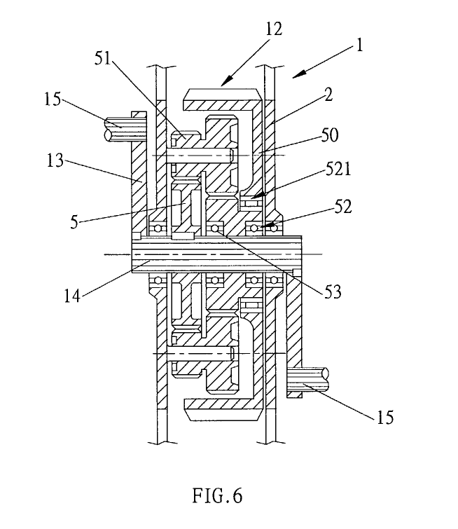

Referring to FIG. 6, the driving apparatus (1) of the present invention adopts the method of enlarging the epicyclical velocity by using an enlarging mechanism to multiply the rotary speed obtained by the driving shaft (14) as it reaches the output end. The mechanism is a lapped gear set mainly comprising the driving shaft (14) movably fastened by the inner hoop body (2) in a same way and externally connected with the symmetrical eccentric shafts (15) through the rotary disk (13). The interior portion of the driving shaft (14) connects fixedly with a driving gear (5); the outer periphery of the driving gear (5) further drives a lapped gear (51) with a smaller wheel diameter; the lapped gear (51) synchronously links a bigger gear and then reversely meshes a passive gear (52) which is coaxial with the driving shaft (14) but has no active relationship. The passive gear (52) drives a spinning disk (50) to output the dynamic force to the engaging plane (12). The engaging plane (12), as shown in FIGS. 4 and 5, indirectly transmits the dynamic force to the motion wheel (4). To intermittently stop pedaling and avoid the spinning disk (50) to reversely feedback the inertia force, a unidirectional engaging apparatus (521) divides the spinning disk (50) and the passive gear (52) for releasing the reverse inertia force. Furthermore, a shaft bearing (53) functions to separate and eliminate the rotary relationship between the passive gear (52) and the driving shaft (14).

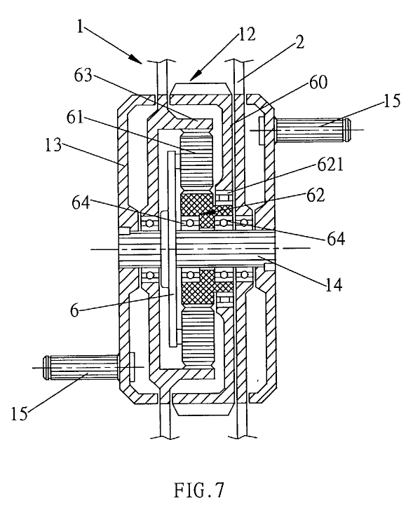

Referring to FIG. 7, in order to enlarge the epicyclical velocity at the output end, the driving apparatus (1) of the present invention adopts an enlarging method of a planet gear (61) which is also movably fastened by the inner hoop body (2) in the same way. An inner cogged ring (63) is horizontally disposed in the interior portion of the inner hoop body (2) as a fixed ring body. After the eccentric shafts (15) drive the driving shaft (14) to rotate, the rotation first drives a planet disk (6) with a plurality of transverse planet gears (61) disposed movably and vertically to mesh the inner cogged ring (63) on the outward side and a sun gear (62) toward the central point. After being multiplied by the driving shaft (14) and all the gears, the rotation speed of the sun gear (62) increases the epicyclical velocity in multiplication. Similarly, the spinning disk (60) outwardly transmits the epicyclical dynamic force to the engaging plane (12); as the same, the motion speed of the engaging plane (12) obtains the circumferential speed through multiplying the epicyclical velocity of the sun gear (62) by the Ludolphian number π. In order to prevent the feedback of the driving inertia force, a unidirectional engaging apparatus (621) is disposed between the sun gear (62) and the spinning disk (60) as well to achieve the function of unidirectional engagement via a unidirectional engaging apparatus (621).

The planet gear (61) is capable of not only enlarging the epicyclical velocity of the sun gear (62) in high multiplication, but also using the planet disk (6) to connect with a plurality of planet gears (61) via the bisection angles. Therefore, the crossed and inward central points of all the planet gears (61) are also located on the central line of the driving shaft (14) such that during the force transmission, the evenly distributed planet gears (61) make the branch force evenly focus at the shaft center of the driving shaft (14) to avoid the loss of declined angles caused by declination thereby transmitting outwardly more complete dynamic force.

The structural design of using the planet gear (61) of the present invention to reversely enlarge the sun gear (62) makes the driving shaft (14) bear more couple; in other words, it is necessary to have more couple in order to enlarge the speed at the terminal end. Therefore, the action force exertion of an exerciser is more force consuming.

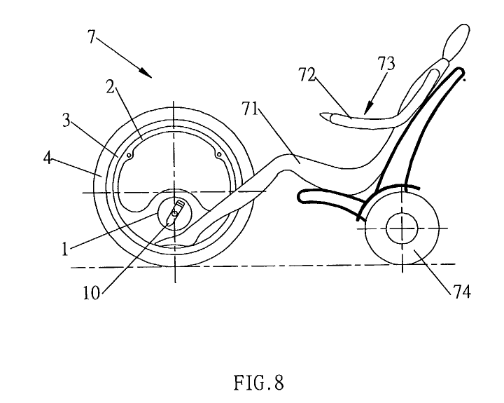

Referring to FIG. 8, the driving wheel body of the present invention is mainly a motion wheel (4); after the link wheel frame (3) functions in the interior thereof, it relatively connects with an inner hoop body (2) which is disposed with an inner tangentially driving apparatus (1). The lateral sides of the driving apparatus (1) are disposed with treadle pedals (10); relative to the inner hoop body (2), a car frame (71) in the shape of a human body extends outwardly to form a man-power leisure exerciser (7). An arm rest (72) and a chair (73) are disposed respectively toward the rearward of the human-shaped car frame (71); the rearward bottom portion thereof is disposed with a rear wheel (74).

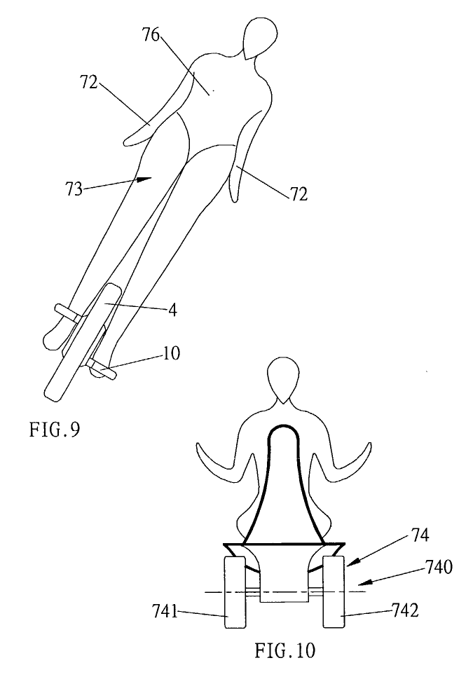

Referring to FIG. 9, the completed structure as shown in FIG. 8 allows a user to sit on the chair (73) from the upper aspect, lean on a seat back (76), hold the arm rests (72) and pedal the treadle pedals (10) to drive forward. The steering process can be handled by using the arm rests (72) to indirectly pull a steel cable (not shown) to move the rear wheel (74) to turn, or by connecting any mechanism to link the rear wheel (74) to turn, or by any other methods which will not be further described.

Referring to FIG. 10, the steering structure of the rear wheel (74) is a deflection mechanism (740) that mainly comprises a structure of four coupling rods with a left rear wheel (741) and a right rear wheel (742) respectively installed on two sides. When the center of gravity of the user's body deflects to the left, the rear wheel (74) deflects to the rear left aspect to achieve the steering application without any manual operation. The deflection mechanism (740) deflects in a regular way similar to that of a general toy car and that will not be further described.

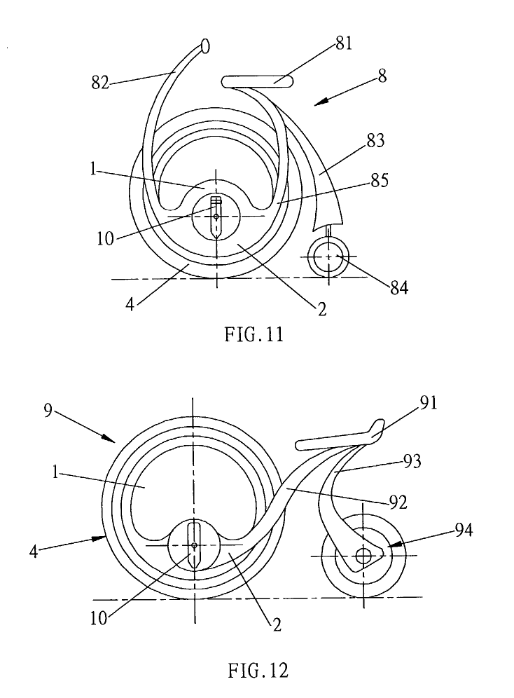

Referring to FIG. 11, the driving apparatus (1) of the present invention is also disposed with the treadle pedal (10) connected outwardly and indirectly with the motion wheel (4). The inner hoop body (2) disposed with the driving apparatus (1) extends outwardly to have a car frame (85) and a handle bar (82); the car frame (85) extends to connect with a seat pad (81) and a rear wheel holder (83). The lower end of the rear wheel holder (83) is disposed with a rear wheel (84) thereby forming a man-power bicycle (8). Therefore, holding the handle bar (82) linearly controls the rear wheel (84) to steer so as to allow the user sitting on the seat pad (81) to keep both feet parallel with the motion wheel (4) for simply pedaling forward. The operation of using linear control to steer is of a regular structural design and that won't be further described.

Referring to FIG. 12, the implementation according to the present invention has an A-shaped exerciser (9) extends from the inner hoop body (2) of the driving apparatus (1). A seat pad (91) is disposed on the upper end of the car frame (92) of the A-shaped exerciser (9) and a rear wheel holder (93) is disposed rearward. The distal end of the rear wheel holder (93) is disposed with a deflection wheel set (94) as well to achieve the application of using the human body's center of gravity to deflect for steering. As the same, the user pedals the treadle pedals (10) to function the driving apparatus (1) to transmit the dynamic force to the motion wheel (4).

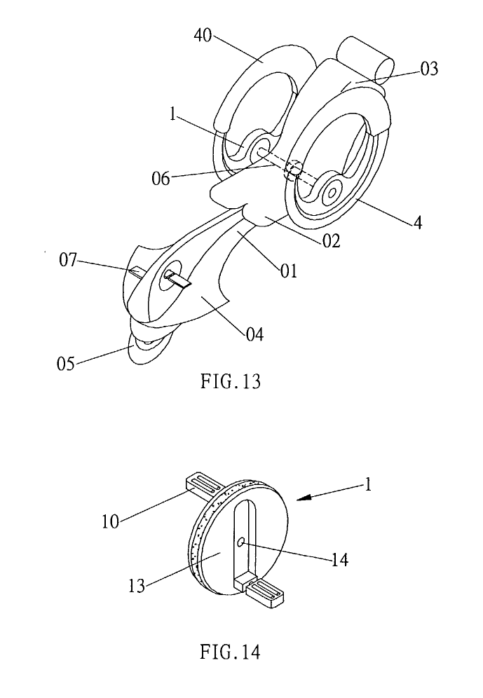

Referring to FIG. 13, the driving apparatus (1) relative to the motion wheel (4) of the present invention is disposed at the position on the tangent point of the lower circle, therefore, two sets of a left and a right motion wheels (4) are oppositely disposed to install a car platform (01) inbetween. The upper aspect of the car platform (01) is disposed with a seat pad (02) and a seat back (03); straddle plates (04) are disposed at the frontward of the car platform (01) for the user's feet to straddle; a steering wheel (05) is movably fastened forwardly at the lower aspect; a treadle device (07) for the user's feet to pedal is disposed upwardly from the steering wheel (05). The treadle device (07) uses a chain or any linking method to transmit the pedaled rotation force to the rear aspect and respectively passes the dynamic force to the driving apparatus (1) disposed respectively on the left and the right sides through a link shaft (06).

The structure indicated in FIG. 13 utilized the mediate position at the center of two opposite motion wheels (4) to install a chassis thereby forming a ground level exerciser. The driving apparatus (1) is located on the tangent point of the lower circle of the motion wheel (4); therefore the installed chassis obtains the lowest installation position. Furthermore, when the chassis reaches the lowest position, the upper half portion of the motion wheel (4) reaches the shoulder portion of the seated user. To prevent the direct touch between the motion wheel (4) and the human body, a shield tube (40) covers the motion wheel (4) to not only increase the pleasant visual effect, but also use the motion wheel (4) located toward the user's lateral side to protect the human body or to act as a arm rest.

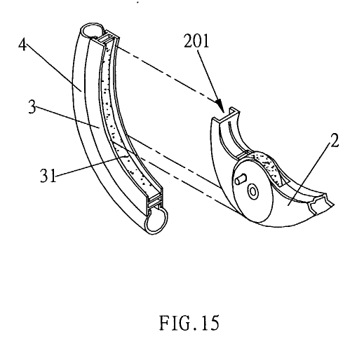

Referring to FIG. 14, the driving apparatus (1) of the present invention comprises a collapsible treadle pedal (10) disposed at the position of the rotary disk (13). The treadle pedal (10) transmits the dynamic force to the driving shaft (14) via the rotary disk (13). The collapsible treadle pedal (10) facilitates the cooperative application among various kinds of exerciser or transportation means so as to provide a practical and convenient application.

Referring to FIG. 15, the following and guiding of the railing adopts a mutual sliding relation to dispose the outer surface as an outward unshaped sliding channel (201) at the positions of ten o'clock and ten minutes past the hour at the opposite upper aspect of the inner hoop body (2). The sliding channel (201) encases the outer side of the inner circle of the link wheel frame (3). Through the sliding relation, the inner hoop body (2) is capable of efficiently aligning with and situating in the inner circle. The abovementioned is suitable for the application of a design with lighter load, such as a toy made of light material.

As indicated in FIG. 13, the chassis structure design of the implementation of the present invention is provided for the handicapped people's vehicles requesting a lower chassis thereby allowing those who have severe walking difficulties to be able to get in at a level t close to the ground surface. In addition, the driving shaft (14) of the driving apparatus (1) is started by an external motor to meet special application request. The driving method of the motor is of a general structural design and that won't be further described.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An inner tangentially driving wheel, more particularly, a wheel capable of lowering a force exertion position, mainly comprises a motion wheel with an inner circle disposed with a man-power pedaling driving apparatus in an indirect relation; the entire driving apparatus is disposed in an inner hoop body which moves correspondingly in the center portion of a link wheel frame via two railing devices; a engaging plane of the driving apparatus downwardly engages and moves a web portion of a tangent point on a lower circle of the link wheel frame; an outer circle of the link wheel frame is provided for assembling the motion wheel.

2. The inner tangentially driving wheel according to claim 1, wherein a unidirectional engaging apparatus is disposed between a driving wheel and a driving shaft of the driving apparatus.

3. The inner tangentially driving wheel according to claim 1, wherein the engaging plane of the driving apparatus frictionally moves the web portion of the link wheel frame.

4. The inner tangentially driving wheel according to claim 1, wherein the movement between the engaging plane of the driving apparatus and the web portion of the link wheel frame is of a gear meshing movement.

5. The inner tangentially driving wheel according to claim 1, wherein the railing device is a lateral guiding wheel sliding tangentially along the link wheel frame.

6. The inner tangentially driving wheel according to claim 1, wherein the driving apparatus utilizes lapped gears to enlarge the epicyclical velocity of the driving wheel.

7. The inner tangentially driving wheel according to claim 1, wherein the driving apparatus adopts a planetary gear set to enlarge the epicyclical velocity of the driving wheel.

8. The lapped gear set according to claim 6, wherein a unidirectional engaging apparatus is disposed between a passive gear and a spinning disk.

9. The planetary gear of the driving apparatus for enlarging the velocity according to claim 7, wherein a unidirectional engaging apparatus is disposed between a sun gear and the spinning disk.

10. A man-power inner tangentially driving exerciser, more particularly a leisure exerciser operated by man-power, mainly comprises a motion wheel relationally assembles a link wheel frame; an inner hoop body is disposed to relatively move in the inner circle of the link wheel frame;
an inner tangentially driving apparatus is disposed at the position of an tangent point in the lower inner circle where the inner hoop body opposites the link wheel frame; the lateral sides of the driving apparatus are disposed with treadle pedals; railing devices are respectively disposed at the position of ten o'clock and ten minutes past the hour on the left and right upward portion of the inner hoop body; the inner hoop body extends outwardly to form a car frame disposed with a seat pad and a rear wheel at the rear lower aspect.

11. The man-power inner tangentially driving exerciser according to claim 10, wherein the rear wheel is a deflection mechanism using a human body's center of gravity to steer.

12. The inner tangentially driving wheel according to claim 1, wherein two sets of wheels are symmetrically on the left and the right sides and have a platform chassis disposed at the central position opposite the driving apparatus to form an exerciser with a lower platform chassis close to the ground surface.

13. The exerciser according to claim 12, wherein the motion wheel is higher than the position of the chassis and is covered by a shield tube.

14. The inner tangentially driving wheel according to claim 1, wherein an outward u-shaped sliding channel is disposed on the outer rim of the inner hoop body to oppositely slide on the outer side of the inner circle of the link wheel frame.

15. The inner tangentially driving wheel according to claim 1, wherein the driving shaft of the driving wheel is driven by a motor.
